(19) United States
(12) Patent Application Publication
(10) Pub. No.: US 2009/0211270 A1
(43) Pub. Date: Aug. 27, 2009

(54) Ice making assembly for refrigerator and method for controlling the same

(76) Inventors: Young Jin Kim, Seoul (KR); Tae Hee Lee, Seoul (KR); Hong Hee Park, Seoul (KR); Ho Youn Lee, Seoul (KR); Joon Hwan Oh, Seoul (KR)

Correspondence Address: MCKENNA LONG & ALDRIDGE LLP, 1900 K STREET, NW, WASHINGTON, DC, 20006, US

(21) Appl. No.: 12/379,537

(22) Filed: Feb. 24, 2009

(30) Foreign Application Priority Data
Feb. 27, 2008 (KR) 10-2008-0017605

(51) Int. Cl. F25C 5/08; F16K 21/18; F25B 49/00; F25C 1/04

(52) U.S. Cl. 62/71; 137/386; 62/126; 62/356; 62/351

(57) ABSTRACT

An ice making assembly for a refrigerator and a method for controlling the ice making assembly. The ice making assembly and the method of controlling the ice making assembly producing transparent ice and capable of preventing water overflow, the freezing of water that has overflowed, and the spilling out of water that has overflowed.

The present application claims priority under 35 U.S.C. 119 and 35 U.S.C. 365 to Korean Patent Application No. 10-2008-0017605 (filed on Feb. 27, 2008), which is hereby incorporated by reference in its entirety.

### BACKGROUND

The present disclosure relates to an ice making assembly for a refrigerator and a method for controlling the ice making assembly.

Refrigerators are domestic appliances used for storing foods by refrigerating or freezing the foods. Recently, various kinds of refrigerators have been introduced into the market. Examples of recent refrigerators include: a side by side type refrigerator in which a refrigerator compartment and a freezer compartment are disposed on the left and right sides; a bottom freezer type refrigerator in which a refrigerator compartment is disposed above a freezer compartment; and a top mount type refrigerator in which a refrigerator compartment is disposed under a freezer compartment.

Furthermore, many of the recently introduced refrigerators have a home bar structure. These permit users to access foods or drinks disposed inside a refrigerator compartment through the home bar (i.e., a relatively small access portal) without having to open the larger refrigerator door.

Refrigerators typically employ a number of refrigeration-cycle components. These include a compressor, a condenser, and an expansion member disposed inside the refrigerator. An evaporator is typically disposed on the backside of the refrigerator main body.

In addition, an ice making assembly may be provided. The ice making assembly may be mounted in the freezer compartment, the refrigerator compartment, on the freezer compartment door, or on the refrigerator compartment door.

To satisfy consumers' increasing demands for transparent ice, ice making assemblies are now being designed to produce ice that is very clear and not cloudy. Accordingly much research has been conducted on ice making assemblies that can provide transparent ice.

Known related art ice making assemblies generally employ an additional water tank disposed at a predetermined side of the refrigerator. It is connected to the ice making tray through a tube which supplies water to the ice making tray. Alternatively, the ice making tray may be directly connected to a tap (i.e., external water source) through a tube.

### SUMMARY

Embodiments provide an ice making assembly for a refrigerator that can produce transparent ice easily and maintain the amount of water supplied for making ice at a constant level for each ice making cycle, and a method for controlling the ice making assembly.

Embodiments also provide an ice making assembly for a refrigerator in which the supply of water is automatically interrupted to prevent overflowing when the water supplied to an ice making tray reaches a set level, and a method for controlling the ice making assembly.

Embodiments also provide an ice making assembly for a refrigerator that can control the amount of water supplied at a constant level regardless of water pressure variations, and a method for controlling the ice making assembly.

Embodiments also provide an ice making assembly for a refrigerator that can reduce unnecessary power consumption by rapidly detecting a water supply error when water is not supplied to the ice making tray due to, for example, a malfunction of a water supply valve, and a method for controlling the ice making assembly.

In accordance with one aspect of the present invention, the capabilities set forth below may be achieved by an ice making assembly that comprises, among other things, a tray configured to receive water. The tray includes a plurality of ice recesses. The assembly also comprises a water level sensor positioned in the tray, where the water level sensor includes a first electrode and a second electrode, the first electrode positioned lower in the tray relative to the second electrode, and wherein an electrical connection between the first and the second electrode occurs upon the water level reaching the second electrode.

In accordance with another aspect of the present invention, the capabilities set forth below may be achieved by a refrigerator ice making assembly control method, where the ice making assembly includes a tray having a plurality of ice recesses and a water level detection sensor that includes a first and a second electrode. The method involves supplying water to the ice recess and allowing the water level in the ice recesses to reach the second electrode, wherein the first and second electrodes are vertically aligned and wherein the first electrode is positioned lower in the tray relative to the second electrode. The method then involves detecting an electrical connection between the first electrode and the second electrode as a result of the water coming into contact with the second electrode. Finally, the method involves determining that the water level has at least reached the second electrode if an electrical connection between the first and the second electrodes is detected.

The ice making assembly and the method of controlling the ice making assembly according to the present disclosure are capable of more easily making transparent ice. This will be clear from the following disclosure.

In addition, the ice making assembly and the method of controlling the ice making assembly are capable of maintaining the level of the supplied water at a constant level for each ice making cycle regardless of water pressure variations. Therefore, water overflow, the freezing of water that has overflowed, and overflow water escaping from the refrigerator can be prevented. Even if varying amounts of water remain in the ice recesses of the tray following an ice making cycle, the desired water level can still be achieved.

Moreover, when water is not supplied to the tray due to, for example, a malfunction in the water supply valve, the present invention is capable of rapidly detecting and reducing power consumption.

In addition, the ice making assembly is capable of detecting the level of water using existing components without using any additional device so that the manufacturing costs of the ice making assembly can be reduced.

### BRIEF DESCRIPTION OF THE DRAWINGS

FIGS. 1 and 2 are perspective views illustrating an ice making assembly structure for a refrigerator according to exemplary embodiments of the prevent invention.

FIG. 3 is a perspective view illustrating an ice making assembly according to exemplary embodiments of the present invention.

FIG. 4 is a perspective view illustrating the ice making assembly prior to ice being transferred to a container.

FIG. 5 is a perspective view illustrating a tray of the ice making assembly according to exemplary embodiments of the present invention.

FIG. 6 is a perspective view illustrating a water level sensor of the ice making assembly according to exemplary embodiments of the present invention.

FIG. 7 is a circuit diagram of an exemplary water level sensor, according to exemplary embodiments of the present invention.

FIG. 8 is a sectional view taken along line I-I′ of FIG. 5 which illustrates the increasing level of water supplied to the tray of the ice making assembly according to exemplary embodiments.

FIG. 9 is a graph illustrating voltage variations in a circuit where water level is increasing.

### DETAILED DESCRIPTION OF THE EMBODIMENTS

Hereinafter, an ice making assembly for a refrigerator will be described in detail according to exemplary embodiments of the present disclosure with reference to the accompanying drawings. In the following description, an ice making assembly is mounted at a freezer compartment door. However, the ice making assembly can alternatively be mounted at other places such as the freezer compartment, the refrigerator compartment, and on the refrigerator compartment door.

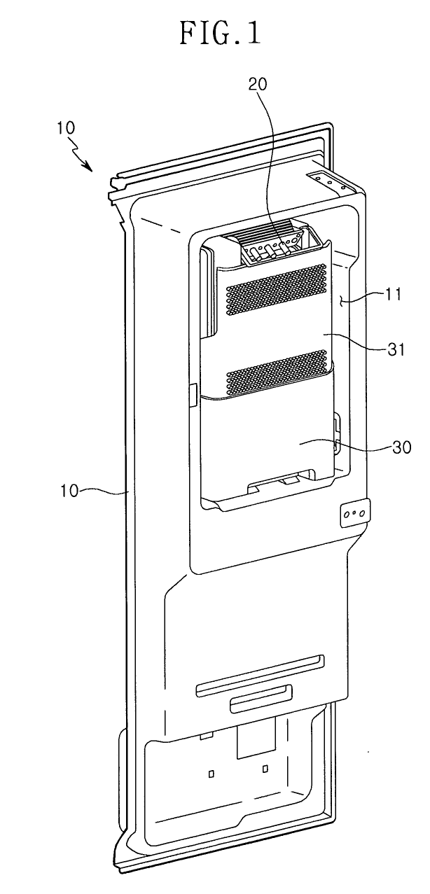

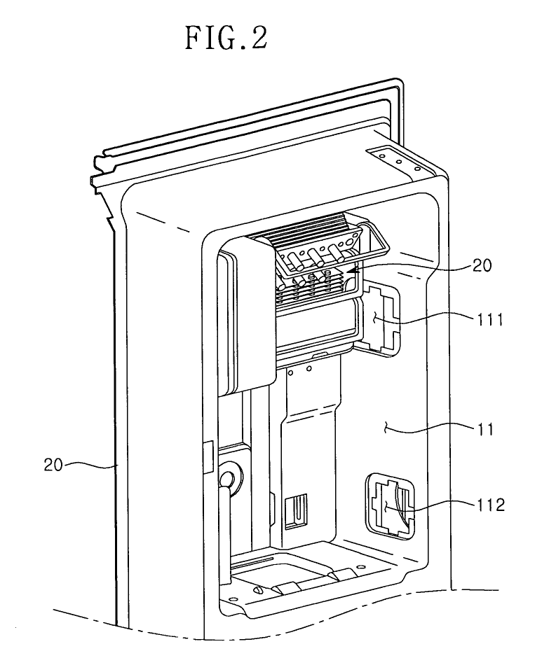

FIGS. 1 and 2 are perspective views illustrating an ice making assembly structure for a refrigerator according to exemplary embodiments of the present invention. As shown, an ice making assembly 20 is mounted on the backside of a door 10, and the backside of the door 10 is recessed to form an ice making assembly space 11 for accommodating the ice making assembly 20. A cooling air supply hole 111 is formed at a side of the ice making assembly space 11 for allowing the inflow of cooling air from an evaporator (not shown), and a cooling air discharge hole 112, formed in the side of the ice making assembly space 11, for allowing the cooling air to be discharged from the ice making assembly space 11 to the evaporator.

The ice making assembly 20 is mounted at an upper portion of the ice making assembly space 11, and a container 30 is mounted under the ice making assembly 20 to store ice made by the ice making assembly 20. The ice making assembly 20 is protected by an ice making cover 31. In addition, owing to the ice making cover 31, ice, when separating from the ice making assembly 20, does not spill outward. It instead falls cleanly into the container 30.

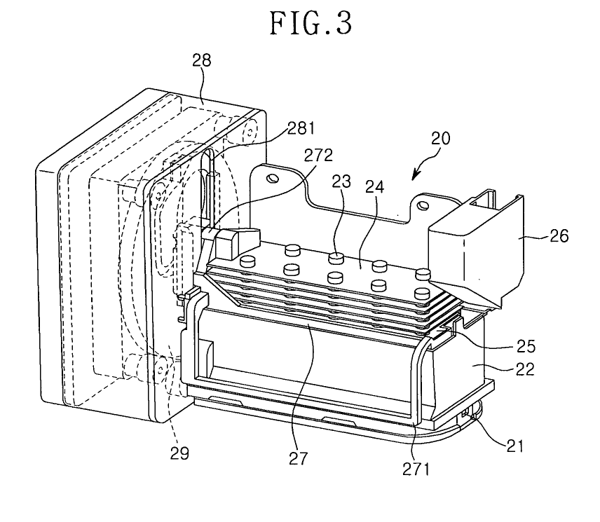

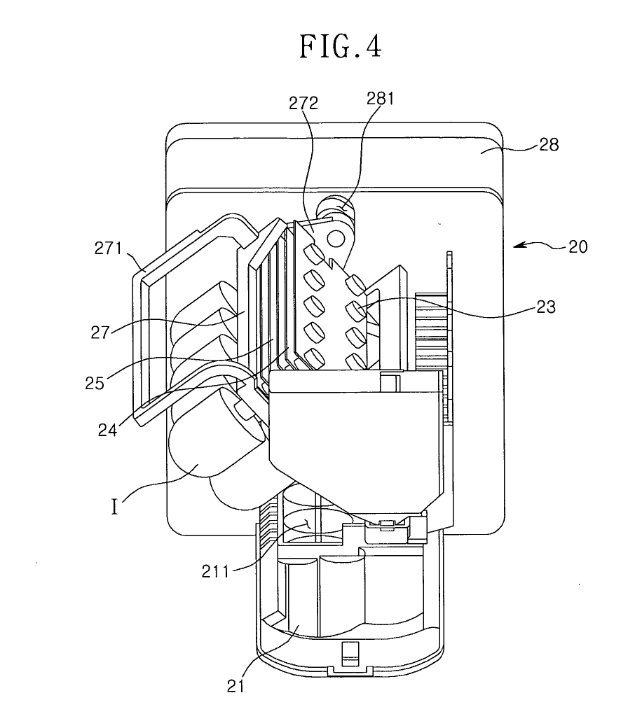

FIG. 3 is a perspective view illustrating the ice making assembly 20 according to exemplary embodiments of the present invention, and FIG. 4 is a perspective view illustrating the ice making assembly 20 just before ice is transferred to the container 30. As shown, the ice making assembly 20 includes a tray 21 having a plurality of ice recesses 211 for making ice in a predetermined shape; a plurality of fins 24 rotatably and movably stacked above the tray 21; a plurality of rods 23 configured to be inserted into the ice recesses 211 through the fins 24; an ice ejecting heater 25 provided at the lowermost fin 24; a supporting plate 27 configured to support the ice ejecting heater 25, the fins 24, and the rods 23 as one unit; a water supply part 26 disposed at an end of the tray 21; and a control box 28 disposed at the opposite end of the tray 21.

A heater (not shown) is mounted at the bottom of the tray 21 to maintain the tray 21 at a temperature higher than freezing. A supporting lever 271 extends from the front of supporting plate 27, and a hinge 272 is formed at one end of the supporting plate 27. During an ice making operation, as shown in FIG. 4, ice (I) having a shape corresponding to the shape of the ice recesses 211 are formed around the rods 23.

Referring again to FIG. 3, a cam 29 and a driving motor for actuating the cam 29 are disposed inside the control box 28. The hinge 272 is connected to the cam 29 so that the hinge 272 can be lifted and rotated by the movement of cam 29. The ice ejecting heater 25 may be form in the shape of a plate and it contacts the rods 23. Alternatively, the ice ejecting heater 25 may be contained inside the rods 23. The supporting plate 27 also serves as a top for tray 21 such that water supplied to the tray 21 is indirectly cooled by the cooling air supplied to the ice making assembly space 11.

Hereinafter, the ice making and ice ejecting operation of the ice making assembly 20 will be described. First, the aforementioned heater attached to tray 21 maintains the tray 21 at a temperature higher than 0° C. This facilitates the process of making transparent ice in the ice making assembly 20 as described in greater detail below.

More particularly, because water is rapidly frozen by cooling air supplied by an evaporator in accordance with known ice making assemblies, air dissolved in the water is trapped in and cannot be discharged from the water during freezing. Consequently, the water freezes with gas dissolved in the water, and this results in cloudy (i.e., non-transparent) ice.

Accordingly, the tray 21 in accordance with exemplary embodiment of the present invention is maintained at a temperature higher than freezing, thus the water freezes slowly so that air dissolved in the water has time to escape the water before the water is frozen. The resulting ice is transparent, not cloudy.

Towards the beginning of the ice making process, the rods 23 are inserted in the ice recesses 211 of the tray 21. Water is then supplied to the tray 21, and the freezing operation begins after the supply of water is completed. The freezing operation begins when cooling air is supplied to the ice making assembly space 11. The temperature of the fins 24 is then reduced to a temperature below freezing by the supplied cooling air. The temperature of the rods 23 is also reduced to a temperature below freezing through conduction with the fins 24. A Portions of each rod 23 is submerged in the water; therefore, the water is gradually frozen beginning with the water located closest to the rods 23. Eventually, water located further from the rods 23 also freeze.

After the water freezing operation is completed, cam 29 is rotated to move the rods 23 out of the ice recesses 211. That is, the cam 29 is rotated to lift the rods 23, and after the ice (I) is removed from the ice recesses 211, the cam 29 is further rotated causing the rods 23 to tilt at a predetermined angle. More specifically, the rotation of the cam 29 causes the hinge 272 to rotate. The rotation of the hinge 272, in turn, causes the rods 23 to tilt at a predetermined angle. When the rods 23 are tilted at a predetermined angle, as shown in FIG. 4, the ice ejecting heater 25 begins operating.

Here, whether freezing of the water is completed may be determined by a predetermined elapse of time from the start of the water freezing operation. That is, if a predetermined time passes after the start of the freezing operation, it may be determined that the water freezing operation is complete.

Alternatively, the cam 29 may be rotated to lift the rods 23 to a predetermined height after a predetermined period of time elapses from the start of the water freezing operation. Here, the predetermined height means a height at which ice attached to the rods 23 is not yet fully separated from the ice recesses 211. If, after the rods 23 are lifted, the amount of water remaining in the ice recesses 211 is equal to or less than a predetermined amount of water, it may be determined that the water freezing operation is complete. The amount of water remaining in the ice recesses 211 can be detected using a water level sensor mounted on the tray 21. On the other hand, if the amount of water remaining in the ice recesses 211 is greater than the predetermined amount, the rods 23 may be are moved downward to the original position to continue the water freezing operation. The water sensor will be described later with reference to the accompanying drawings.

After the water freezing operation has been completed, and the rods 23 have been lifted and rotated as explained above, the ice ejecting heater 25 is operated. This causes the temperature of the rods 23 to increase. Eventually, the temperature of the rods causes the ice pieces (I) to separate from the rods 23. The separated ice pieces (I) then falls cleanly into the container 30.

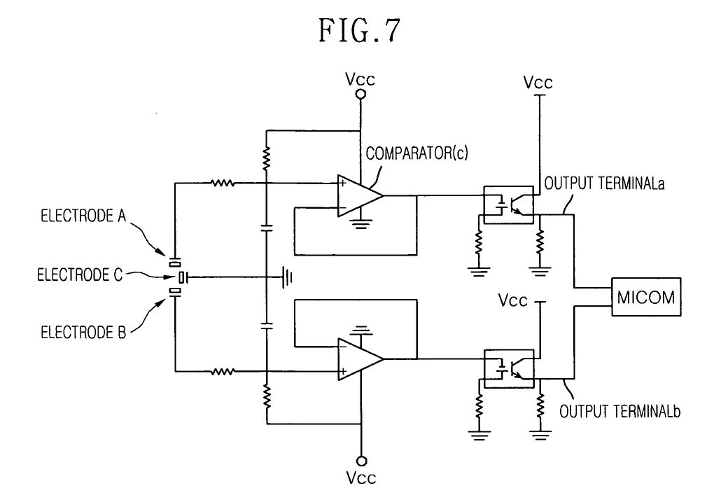

Further in accordance with the exemplary embodiments of the present invention, the position of the rods relative to the ice recesses may be user adjustable. For example, the user may have an option to select the size of the ice that is produced by the ice making assembly, through the use of a selection button and a corresponding control circuit. The position of the rods relative to the ice recesses is then adjusted as a function of the user's selection. If the user wants the ice making assembly to produce small sized ice, it will be understood, from the preceding disclosure that the position of the rods will be automatically set relative far down in the ice recesses. Accordingly, when water is supplied to the tray, a relatively small amount of water will be required to achieve an electrical connection between the rods and the tray. When the connection is achieved, the control circuit, such as the control circuit illustrated in FIG. 7, stops the water supply and smaller sized ice is ultimately produced as less water was used to fill the tray. If the user instead chooses medium or large sized ice, the rods will not be positioned as far down in the ice recesses as was the case with smaller sized ice, thus allowing a greater amount of water to be supplied to the tray, resulting in larger sized ice.

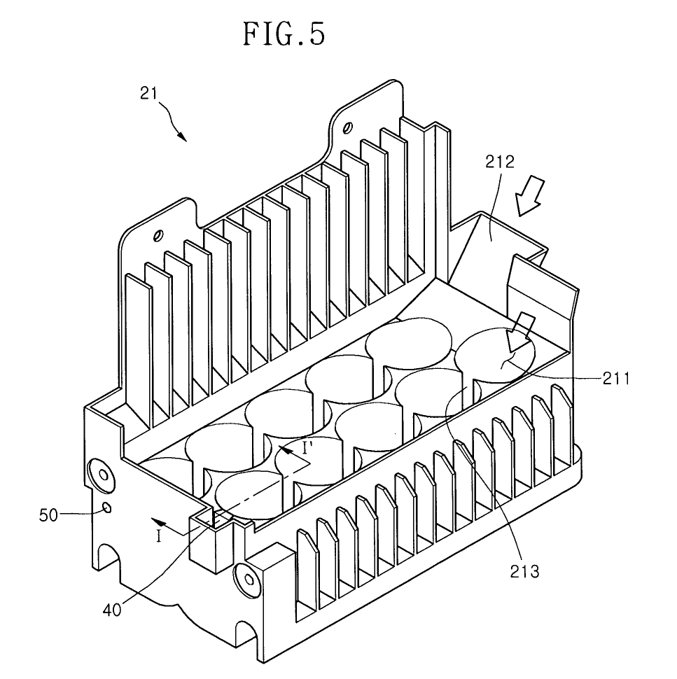

FIG. 5 is a perspective view illustrating the tray 21 of the ice making assembly 20 according to an embodiment. As shown, tray 21 includes ice recesses 211. Grooves 213 having a predetermined depth are formed between the ice recesses 211, allowing water to pass there through to evenly fill all of the ice recesses 211.

A guide 212 is formed at one end of the tray 21 to guide water supplied to the tray 21 and into the ice recesses 211. Therefore, water supplied through the water supply part 26 is guided into the ice recesses 211 by guide 212. Water is supplied to the ice recesses 211 gradually from the ice recess 211 closest to the guide 212 to the ice recess 211 farthest from the guide 212.

A water level sensor 40 is mounted at one side of the ice recess 211, preferably opposite to the guide 212. Further, a temperature sensor 50 is mounted at one side of the tray 21 to maintain the tray 21 at a constant temperature. A tray heater (not shown) is installed at the tray 21 or, alternatively, integrated into the tray 21.

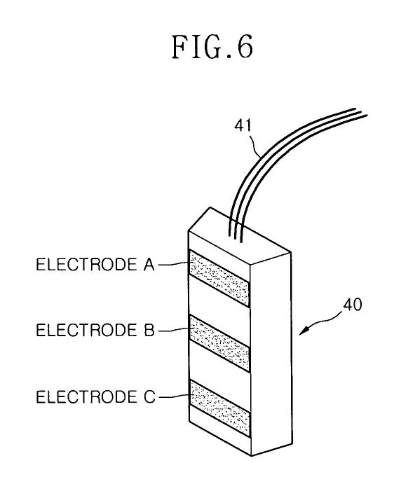

FIG. 6 is a perspective view illustrating the water level sensor 40 of the ice making assembly 20 according to exemplary embodiments of the present invention. As shown, the water level sensor 40 may be mounted at one side of the ice recess 211 as described above. The water level sensor 40 comprises a number of electrodes that are employed to detect the water level in the ice recesses. In general, this is achieved by applying a voltage to the electrodes and measuring current flowing through the water, between the electrodes.

More specifically, the water level sensor 40 includes a plurality of electrodes. In addition, output lines 41 extend from the electrodes and are connected to a refrigerator control unit (not shown).

In this exemplary embodiment, the water level sensor 40 includes three electrodes: Electrode A, a middle electrode B, and a lower electrode C. When the water level sensor 40 is attached to the tray 21, electrode A may be located at a position slightly lower than the highest expected water level. Electrode C may be located at a position just higher than the bottom of the tray 21 (i.e., the ice recesses 211). For example, electrode C may be located at a height that corresponds with the bottom of the groove 213.

An exemplary operation of the water level sensor 40 during a water supplying operation will now be explained. FIG. 7 is an exemplary circuit for implementing the water level sensor 40 according to exemplary embodiments of the present invention. As shown, the electrodes A, B, and C of the water level sensor 40 generate sensor signals according to the water level. The sensor signals are then transmitted to a control unit (MICOM).

In this exemplary embodiment, electrode C is grounded, and the electrodes A and B are electrically connected to electrode C depending on the level of supplied water. Also as shown, the circuit includes an output terminal (a) which generates an on-signal associated with electrode A. Output terminal (b) generates an on-signal associated with electrode B. The output terminals (a) and (b) are connected to the control unit. Comparators (c) are provided in the circuit for comparing a reference voltage Vcc to a voltage V which is generated when electrode A and/or B is connected to electrode C by virtue of the water level.

In the above-described circuit, as water is supplied to the tray 21, the level of water in the ice recess 211 increases. If the water level is lower than electrode C or located between electrodes B and C, neither output terminal (a) or (b) will generate an output signal because the electrode C is grounded. In this case, both electrode A and B are open circuit with electrode C. This results in a low voltage output at the corresponding comparator (C). This, in turn, prevents the corresponding output terminal (a) and/or (b) from generating an on-signal.

If the water level of the ice recess 211 increases to the height sufficient to electrically connect electrode B to the electrode C, then corresponding output terminal (b) generates an on-signal. That is, if electrodes B and C are electrically connected to each other, by virtue of the water, the voltage of the output terminal (b) decreases steeply as current flows through the transistor, thus generating an on-signal. The control unit detects this on-signal and determines that the water level has at least reached the height of electrode B.

If the water level of the ice recess 211 increases to a height sufficient to electrically connect electrode A to electrode C, then the corresponding output terminal (a) similarly generates an on-signal. The control unit can then detect the on-signal from output terminal (a) and determine that the water level has at least reached the height of electrode A.

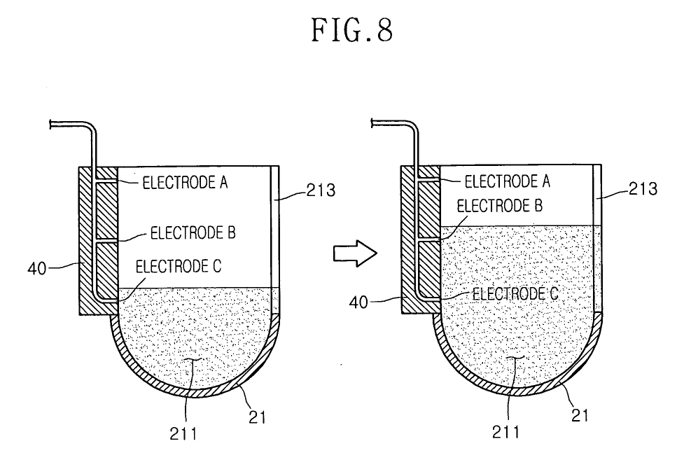

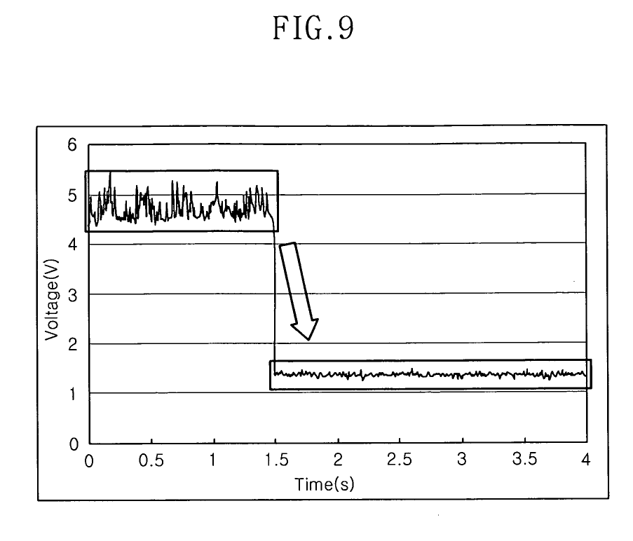

FIG. 8 is a sectional view taken along line I-I′ of FIG. 5. More specifically, FIG. 8 illustrates the increasing level of water supplied to tray 21 of the ice making assembly 20, in relation to electrodes A, B and C, according to exemplary embodiments of the present invention. FIG. 9 is a graph illustrating a voltage variation that is realized across the output terminal (b) when the level of water reaches a height sufficient to electrically connect electrode B to electrode C.

With further reference to FIGS. 8 and 9, until the level of water supplied to the ice recess 211 of the tray 21 increases to the height of electrode B, the voltage of the circuit (i.e., the output voltage associated with output terminal (b)) is kept substantially at a constant level Vcc. However, when the level of water increases to the height of electrode B, the voltage of the circuit (i.e., across the output terminal (b) decreases from Vcc to V, where V is a substantially lower voltage level. The control unit detects this voltage drop (Vcc−V) and uses this to determine that the water level has reached a height in the tray 21 which is at least as high as electrode B.

In contrast, when the ice recess 211 is not filled with water, there is no electrical connection between electrodes B and C, nor between electrodes A and C. The corresponding Comparator (c) outputs a low voltage, the corresponding output terminal is biased OFF and the voltage realized at the output terminal is the source voltage V.

However, when water is supplied to the ice recess 211 to the height of electrode B, a relatively low resistance forms between electrodes B and C due to the supplied water. Since the resistance of water is lower than that of air, the voltage of the circuit (i.e., the voltage across the output terminal(b)) drops as current flows from the source to the drain of the transistor associated with output terminal (b). The control unit detects the voltage drop and uses this to determine that the water level has at least reached electrode B.

If the level of water further increases to the height of electrode A, the same voltage variation (Vcc−V) is observed at output terminal (a) as shown in FIG. 9. That is, if the level of water reaches the height of electrode A, a voltage drop occurs at the output terminal (a). The control unit detects the voltage drop at the output terminal (a) and uses this to determine that the water level has at least reached the height of electrode A.

Thus, when the level of water reaches the height of electrode B, a voltage drop is detected at the output terminal (b), and when the level of water increases to the height of the electrode A, a voltage drop is detected at the output terminal (a).

Owing to the above-described structure, the amount of water supplied to the tray 21 can be precisely detected, and thus water overflow can be prevented, the freezing of overflowing water can be prevented, and water escaping from the refrigerator can be prevented.

Furthermore, if an expected level of water is not detected within a predetermined time after a water supply valve is opened, the control unit can determine that there is a water supply error, and suspend the water freezing operation. Therefore, unnecessary heater operation and the unnecessary supplying of cooling air can be prevented.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An ice making assembly for a refrigerator, the ice making assembly comprising:
a tray configured to receive water, the tray including a plurality of ice recesses;
a water level sensor positioned in the tray, the water level sensor including a first electrode and a second electrode, the first electrode positioned lower in the tray relative to the second electrode, wherein an electrical connection between the first and the second electrode occurs upon the water level reaching the second electrode.

2. The ice making assembly according to claim 1, further comprising:
control circuitry; and
a control unit, the control circuitry configured to generate a first signal if there is an electrical connection between the first electrode and the second electrode, and wherein the control unit is configured to detect whether the control circuitry has generated the first signal and to determine the water level has at least reached the second electrode if the control circuit has generated the first signal.

3. The ice making assembly according to claim 2, further comprising:
a third electrode, wherein the first electrode and the second electrode are positioned lower in the tray relative to the third electrode, wherein an electrical connection between the third electrode and the first electrode occurs upon the water level reaching the third electrode.

4. The ice making assembly according to claim 3, wherein the control circuitry is further configured to generate a second signal if there is an electrical connection between the first electrode and the third electrode, and wherein the control unit is further configured to detect whether the control circuitry has generated the second signal and to determine that the water level has at least reached the third electrode if the control circuit has generated the second signal.

5. The ice making assembly according to claim 4, wherein the first, second and third electrodes are vertically arranged at predetermined intervals.

6. The ice making assembly according to claim 1, further comprising:
a plurality of fins positioned above the tray; and
a plurality of rods, each of the plurality of rods extending through the stack of fins and adapted such that a portion thereof is positioned within a corresponding one of the plurality of ice recesses.

7. The ice making assembly according to claim 6, wherein the fins are exposed to cooling air during a water freezing operation, and the fins and the rods are configured such that the rods are cooled by conduction to a water freezing temperature.

8. The ice making assembly according to claim 7, wherein the rods and the fins are configured to be lifted and rotated to a predetermined angle as a single unit, after the water freezing operation is completed, such that no portion of the rods are positioned in the ice recesses.

9. The ice making assembly according to claim 8, wherein each of the plurality of rods is configured as an ice ejecting heater.

10. A refrigerator ice making assembly control method, wherein the ice making assembly includes a tray having a plurality of ice recesses and a water level detection sensor that includes a first and a second electrode, the method comprising:
supplying water to the ice recess;
allowing the water level in the ice recesses to reach the second electrode, wherein the first and second electrodes are vertically aligned and wherein the first electrode is positioned lower in the tray relative to the second electrode;
detecting an electric connection between the first electrode and the second electrode as a result of the water coming into contact with the second electrode; and
determining that the water level has at least reached the second electrode if an electrical connection between the first and the second electrodes is detected.

11. The method according to claim 10, wherein the water level sensor further comprises a third electrode and wherein the first and the second electrodes are positioned lower in the tray relative to the third electrode, the method further comprising:
detecting an electric connection between the first electrode and the third electrode as a result of the water coming into contact with the third electrode; and
determining that the water level has at least reached the third electrode if an electrical connection between the first and the third electrodes is detected.

12. The method according to claim 10, further comprising:
determining that there is a water supply error if it is determined that the water level has not reached the second electrode after a predetermined period of time has elapsed.

13. The method according to claim 10, wherein the ice making assembly further includes a plurality of rods positioned above the tray, the method further comprising:
moving, in a downward direction, each of the plurality of rods such that at least a portion of each rod is positioned in a corresponding one of the plurality of ice recesses.

14. The method according to claim 13, wherein supplying the water starts after the plurality of rods are moved downward, the method further comprising:
initiating a water freezing operation after the water has been supplied to the tray.

15. The method according to claim 14, further comprising:
after the water freezing operation is complete, lifting the rods to a position where the rods are spaced apart from a top side of the ice recesses;
rotating the rods by a predetermined angle; and
heating the rods to separate ice from the rods.

16. The method according to claim 10, wherein the tray is maintained at a temperature above freezing while the water is frozen.
